(19) United States
(12) Patent Application Publication
(10) Pub. No.: US 2022/0322869 A1
(43) Pub. Date: Oct. 13, 2022

(54) IMITATED POUR-OVER COFFEE MAKER CAPABLE OF HIGH-TEMPERATURE CONTROL

(71) Applicants: Tzu-Chi LIN, Taipei City (TW); Hsien-Jen LIN, Taipei City (TW)

(72) Inventors: Tzu-Chi LIN, Taipei City (TW); Hsien-Jen LIN, Taipei City (TW)

(21) Appl. No.: 17/225,159

(22) Filed: Apr. 8, 2021

(51) Int. Cl. A47J 31/56; A47J 31/44; A47J 31/52; A47J 31/46

(52) U.S. Cl. CPC A47J 31/56; A47J 31/4457; A47J 31/5253; A47J 31/5255; A47J 31/461; A47J 2202/00; A47J 2203/00

(57) ABSTRACT

Provided is an imitated pour-over coffee maker capable of high-temperature control, including: a body having therein a water tank and a coffee-making tank; a human-machine interface module; a first coffee-making module; a second coffee-making module; a first control module; and a second control module for reading a signal of a third temperature sensor to control a second solenoid valve to perform coffee-making commencement or perform water-return commencement for returning water to the coffee-making tank. High-temperature control can be exercised over water dispensed by the delivery head, thereby optimizing the automation of imitated pour-over coffee making.

### BACKGROUND OF THE INVENTION

### 1. Technical Field

The present disclosure relates to imitated pour-over coffee makers capable of high-temperature control and, more particularly, to an imitated pour-over coffee maker capable of high-temperature control and conducive to an imitated pour-over coffee making process with a view to effecting automation of imitated pour-over coffee making.

### 2. Description of Related Art

Worldwide consumer staples sector grows rapidly, thanks to ever-increasing beverage consumers. Furthermore, the global beverage market nowadays is an ever-changing all-rounder, offering new products, such as instant coffee, tea leaves, flower tea, fruit tea, Chinese herbal life-nurturing tea, etc.

Pour-over coffee is always popular with coffee drinkers, because its mouthfeel and flavor not only differs from person to person but is also distinguished. However, not only is pour-over coffee offered at high prices, but making delicious pour-over coffee also require considerable training and expertise. Therefore, making imitated pour-over coffee smartly with automated equipment would work to coffee businesses' and consumers' benefit.

Every conventional process of making imitated pour-over coffee with commercialized equipment is confronted with an important issue—a large amount of imitated pour-over coffee must be made in a short period of time. Therefore, it is important to supply coffee-making hot water at steady temperature, effectively and continuously. Another issue which seriously affects the flavor of the imitated pour-over coffee is the lower temperature of the water in a pipeline, especially metallic pipeline, between the coffee-making tank and the delivery head at the beginning of the process of coffee making.

### BRIEF SUMMARY OF THE INVENTION

It is an objective of the present disclosure to provide an imitated pour-over coffee maker capable of high-temperature control with a view to making imitated pour-over coffee with automated equipment and optimizing the flavor of the imitated pour-over coffee by means of precise water temperature control.

In order to achieve the above and other objectives, the present disclosure provides an imitated pour-over coffee maker capable of high-temperature control, comprising: a body comprising a main casing and a base, the body having therein: a water tank in communication with a water source through a first solenoid valve; a first water gauge located at a position for measuring a level of water in the water tank and adapted to control the first solenoid valve to open or shut; a coffee-making tank being in communication with the water tank through a first pump, a second solenoid valve and an instantaneous heater and having a coffee-making heater; a second water gauge located at a position for measuring a level of water in the coffee-making tank and adapted to control the first pump and the second solenoid valve to open or shut; a first temperature sensor disposed at an outlet end of the instantaneous heater; a second temperature sensor located at a position for measuring a temperature of water in the coffee-making tank; and a flowmeter disposed between the coffee-making tank and the water tank; a human-machine interface module disposed at a top of the main casing; a first coffee-making module comprising: a first driving module for enabling its first moving unit to perform a first motion operation; a second driving module fixedly disposed on the first moving unit and adapted to drive its second moving unit to perform a second motion operation; and a delivery head fixedly disposed on the second moving unit and having a water inlet in communication with a water outlet of the coffee-making tank through a second pump and a third solenoid valve; and a third temperature sensor disposed at a position for sensing a temperature of water dispensed by the delivery head; a second coffee-making module comprising: a cup holder disposed at the base; and a third driving module for controlling the cup holder to perform rotation operation; a first control module for reading a signal of the human-machine interface module and then controlling the first driving module and the second driving module to not only allow the delivery head to perform upward, downward, forward and backward coffee-making operation but also control the third driving module to drive rotation of a coffee cup ready to contain coffee to be made, thereby performing imitated pour-over coffee making operation; and a second control module for reading a signal of the human-machine interface module and performing the steps of: reading a coffee-making command of the human-machine interface module, driving the second pump to supply coffee-making hot water, reading a set water level of the human-machine interface module to use the set water level as a predetermined value, reading an actual flow rate shown on the flowmeter, comparing the predetermined value with the actual flow rate, so as to stop driving the second pump when the actual flow rate reaches the set water level; reading a first temperature signal of the first temperature sensor and a predetermined dispensed water temperature of the instantaneous heater, thereby controlling a heating operation of the instantaneous heater; reading the set temperature of the human-machine interface module and a second temperature signal of the second temperature sensor, thereby controlling a heating operation of the coffee-making heater; and reading the set temperature of the human-machine interface module and a third temperature signal of the third temperature sensor, so as to control the third solenoid valve to perform a coffee-making commencement operation or perform a water-return commencement operation for returning water to the coffee-making tank.

The present disclosure can be implemented to achieve at least the inventive advantages as follows:
1. exercise precise temperature control and thereby optimize the flavor of the coffee made;
2. make imitated pour-over coffee with automated equipment;
3. enable users to make delicious pour-over coffee conveniently without training; and
4. make imitated pour-over coffee massively and efficiently with automated equipment and create novel commercial models.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

FIG. 1 is a perspective schematic view of an imitated pour-over coffee maker capable of high-temperature control according to the present disclosure.

FIG. 2A is a partial perspective schematic view of the imitated pour-over coffee maker capable of high-temperature control according to the present disclosure.

FIG. 2B is an exploded view of a first coffee-making module of the present disclosure.

FIG. 2C is a schematic view of the interior of a body of the imitated pour-over coffee maker capable of high-temperature control according to the present disclosure.

FIG. 3 is a partial cross-sectional view of the imitated pour-over coffee maker capable of high-temperature control according to the present disclosure.

FIG. 4 is a block diagram (1) of a circuit of the present disclosure.

FIG. 5 is a schematic view of making imitated pour-over coffee according to the present disclosure.

FIG. 6A is a block diagram (2) of a circuit of the present disclosure.

FIG. 6B is a schematic view of a process flow of controlling an instantaneous heater to operate.

FIG. 6C is a schematic view of a process flow of controlling a coffee-making heater to operate.

FIG. 6D is a schematic view of a process flow of controlling a second solenoid valve and a third pump.

FIG. 6E is a schematic view of a process flow of controlling a flowmeter and a second pump.

### DETAILED DESCRIPTION OF THE INVENTION

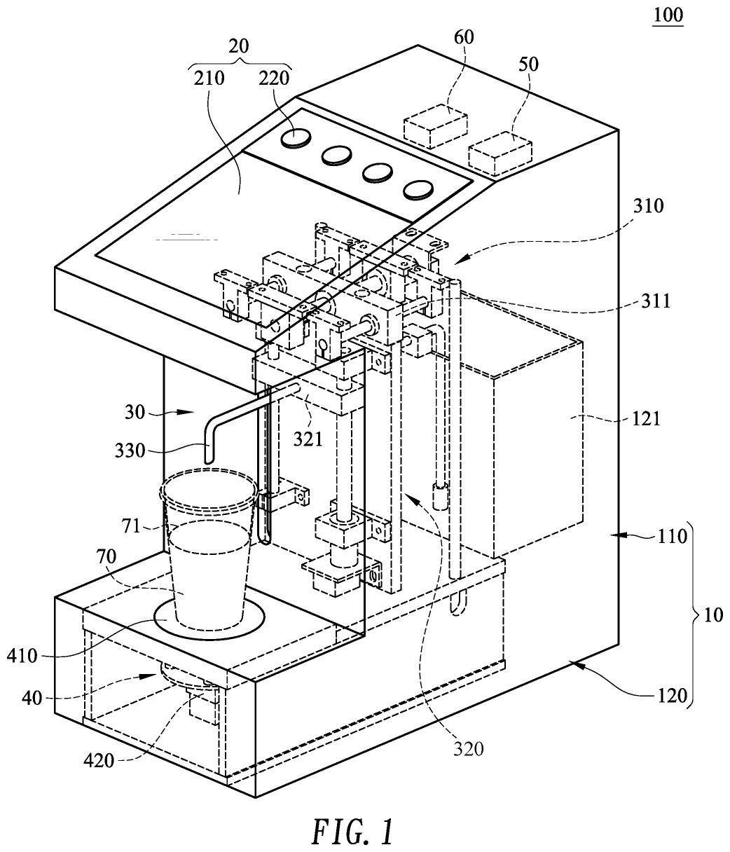

Referring to FIG. 1, an imitated pour-over coffee maker 100 capable of high-temperature control is provided according to an embodiment of the present disclosure and comprises a body 10, a human-machine interface module 20, a first coffee-making module 30, a second coffee-making module 40, a first control module 50, and a second control module 60.

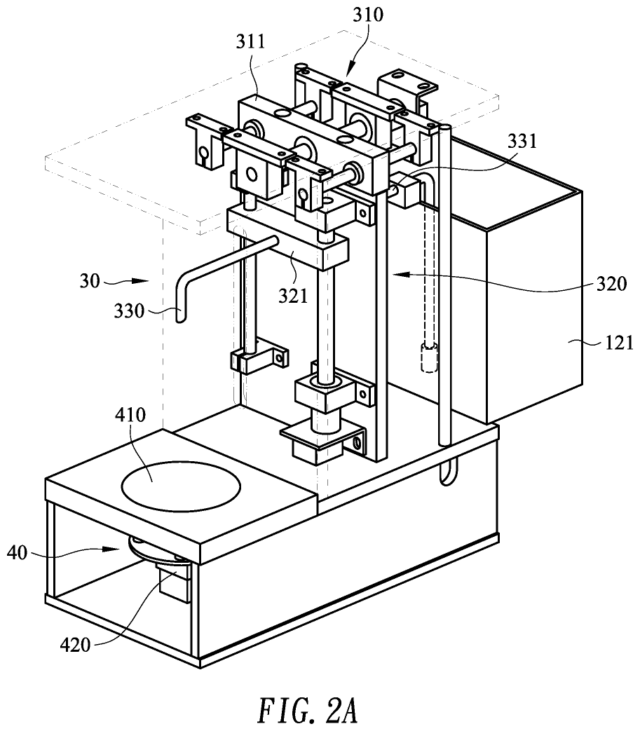

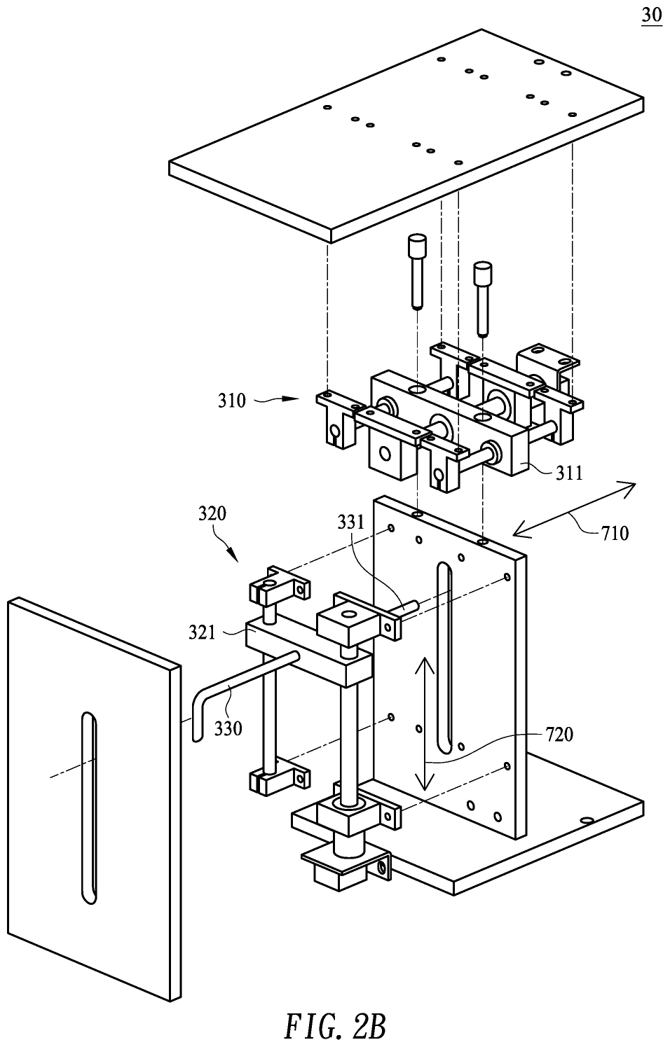

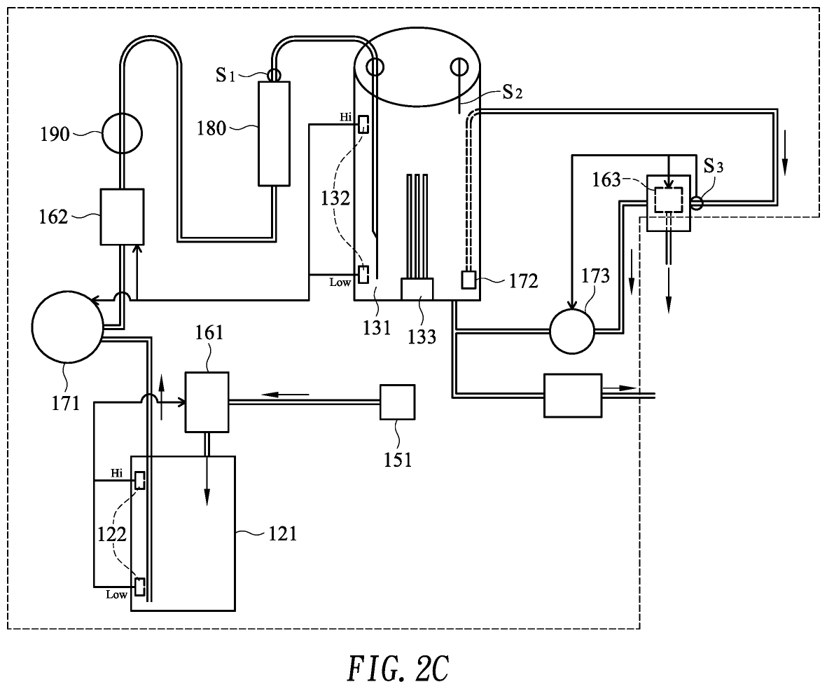

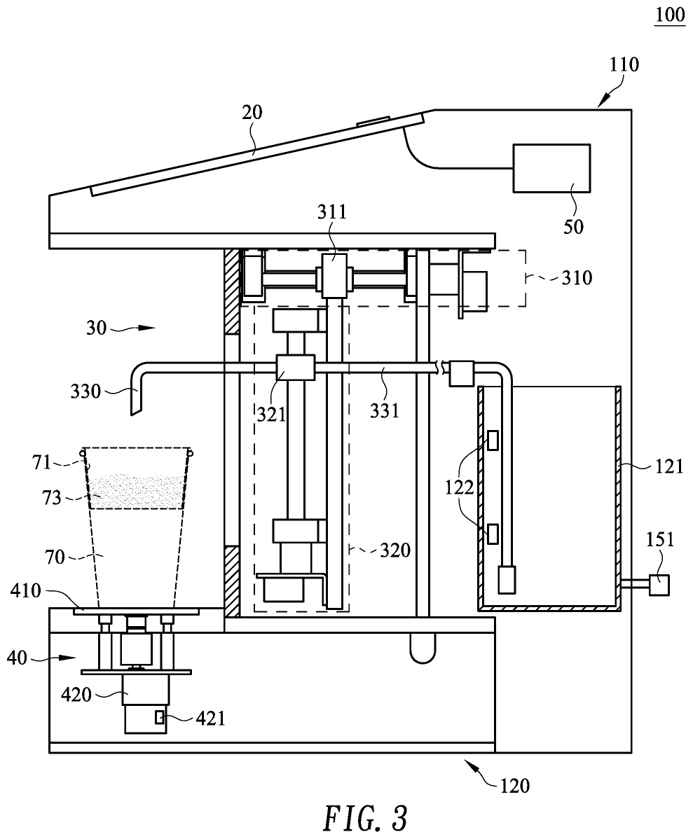

Referring to FIG. 1 through FIG. 4, the body 10 is essentially a casing which comprises a main casing 110 and a base 120. The main casing 110 receives a human-machine interface module 20, a first coffee-making module 30, a first control module 50 and a second control module 60. The base 120 has therein a second coffee-making module 40.

The body 10 further has therein a water tank 121, a first water gauge 122, a coffee-making tank 131, a second water gauge 132, a first temperature sensor S₁, and a second temperature sensor S₂.

The water tank 121 stores cool water from a water source 151. The water tank 121 is in communication with the water source 151 and is controlled by a first solenoid valve 161 to open or shut.

The first water gauge 122 is located at a position for measuring the level of water in the water tank 121 and adapted to control the first solenoid valve 161 to open or shut, thereby automating the control of the level of water in the water tank 121.

The coffee-making tank 131 is in communication with the water tank 121 through a first pump 171, a second solenoid valve 162 and an instantaneous heater 180. The coffee-making tank 131 has a coffee-making heater 133. To effectively maintain water supply, the capacity of the water tank 121 is at least three times greater than that of the coffee-making tank 131.

The second water gauge 132 is located at a position for measuring the level of water in the coffee-making tank 131 and adapted to control the first pump 171 and second solenoid valve 162 to open or shut. When the second water gauge 132 detects that the coffee-making tank 131 has a low water level Lo, both the first pump 171 and second solenoid valve 162 open, thereby replenishing the coffee-making tank 131. When the second water gauge 132 detects that the coffee-making tank 131 has a high water level Hi, both the first pump 171 and second solenoid valve 162 shut to stop replenishing the coffee-making tank 131.

The first temperature sensor S₁ is disposed at an outlet end of the instantaneous heater 180. The second temperature sensor S₂ is located at a position for measuring the temperature of water in the coffee-making tank 131.

The human-machine interface module 20 enables users to select the options for making coffee. The human-machine interface module 20 is disposed at the top of the main casing 110 to allow the users to operate the imitated pour-over coffee maker 100 conveniently. The human-machine interface module 20 is a touchscreen 210 or a button assembly 220.

The first coffee-making module 30 comprises a first driving module 310, a second driving module 320, a delivery head 330, and a third temperature sensor S₃.

The first driving module 310 enables its first moving unit 311 to perform a first motion operation. The first motion operation is a horizontal motion operation. In order to control the displacement precisely, the first driving module 310 is a linear rail or a ball screw positioning transmission mechanism.

The second driving module 320 is fixedly disposed on the first moving unit 311. Thus, when the first moving unit 311 moves, it drives the second driving module 320 to move synchronously with it.

The second driving module 320 enables its second moving unit 321 to perform a second motion operation. The second motion operation is a vertical motion operation. In order to control the displacement precisely, the second driving module 320 is a linear rail or a ball screw positioning transmission mechanism.

The delivery head 330 supplies hot water required for making coffee. The delivery head 330 is a pipelike structure. The delivery head 330 is fixedly disposed on the second moving unit 321. Therefore, when the second moving unit 321 moves, the delivery head 330 moves together with the second moving unit 321 synchronously.

A water inlet of the delivery head 330 is in communication with a water outlet of the coffee-making tank 131 through a second pump 172 and a third solenoid valve 163; hence, the delivery head 330 can supply the hot water required for making coffee.

The third temperature sensor S₃ is located at a position for sensing the temperature of water admitted to the delivery head 330.

The second coffee-making module 40 comprises a cup holder 410 and a third driving module 420.

The cup holder 410 is a rotatable disk on which a coffee cup 70 ready to contain coffee to be made lies. The cup holder 410 is disposed at the base 120 and below the delivery head 330 to facilitate coffee making.

The third driving module 420 is a motor. The third driving module 420 controls the cup holder 410 to perform rotation operation (i.e., to rotate). To effectively control the rotation speed of the motor, the third driving module 420 operates in conjunction with a rotation speed controller 421 and uses, for example, pulse width modulation (PWM) technology.

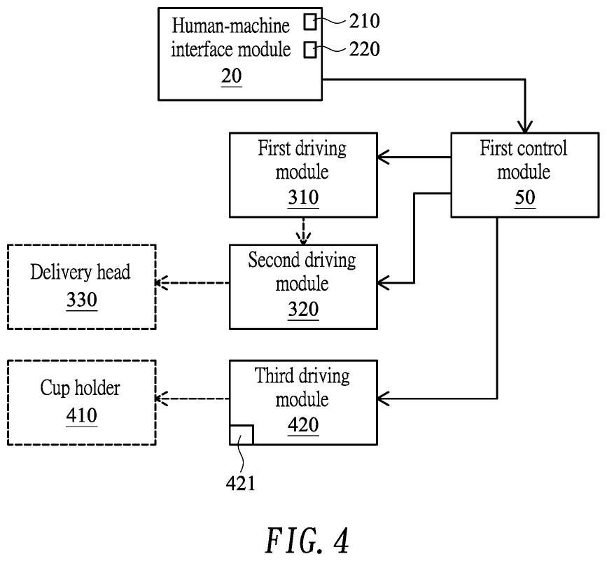

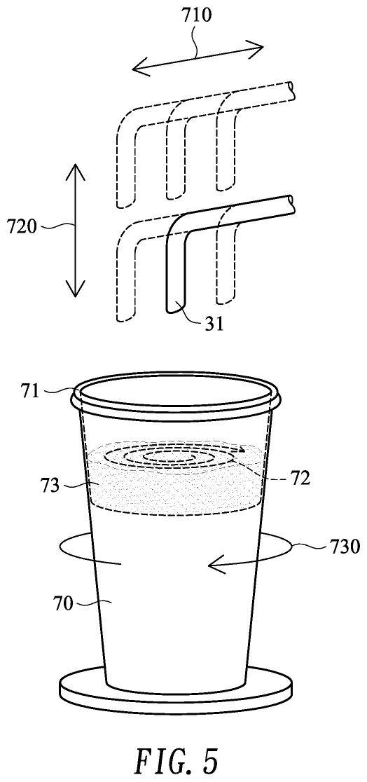

Referring to FIGS. 4, 5, the first control module 50 reads signals of the human-machine interface module 20 and then controls the first driving module 310 and second driving module 320 to not only allow the delivery head 330 to perform upward, downward, forward and backward coffee-making operation but also control the third driving module 420 to drive the rotation of the coffee cup 70, thereby performing imitated pour-over coffee-making operation 72.

In addition to the aforesaid imitated pour-over coffee making operation, considerations must be given to consumer preference for coffee flavor, different coffee-making process flows, and different coffee-making parameters, in order to make the best imitated pour-over coffee.

The first control module 50 controls the imitated pour-over coffee maker 100 with a well-designed, well-planned built-in program. The first control module 50 is a programmable controller, for example, a microcontroller unit (MCU). The first control module 50 is in electrical signal connection with the human-machine interface module 20, first coffee-making module 30, and second coffee-making module 40.

The users enter a coffee-making command to the human-machine interface module 20, such that the human-machine interface module 20 generates and sends a control signal to the first control module 50. Then, the first control module 50 controls the modules or components of the imitated pour-over coffee maker 100 according to built-in program code.

To illustrate how the human-machine interface module 20 works and how to make imitated pour-over coffee, the design of the human-machine interface module 20 and the first control module 50 is described as follows:

| | Control module operation | | | | | | |
|---|---|---|---|---|---|---|---|
| Human- | | | | | First | Second | Third |
| machine | | Bean | Water | Water | instance | instance | instance |
| interface | Cup | soaking and | temperature | quantity | of coffee | of coffee | of coffee |
| input (flavor) | warming | preheating | T₀ | Wₒ | making | making | making |
| Americano | V(done) | V(done) | 93° C. | 150_{CC} | 50_{CC} | 50_{CC} | 50_{CC} |
| Caffè latte | V(done) | V(done) | 94° C. | 130_{CC} | 60_{CC} | 70_{CC} | X (not |
| | | | | | | | done) |
| Espresso | V(done) | V(done) | 95° C. | 80_{CC} | 20_{CC} | 30_{CC} | 30_{CC} |

First, the human-machine interface module 20 is pre-configured with flavor options anticipated by the users, such as Americano, Calf& Latte, and Espresso. Afterward, the built-in program imitates conventional process flows of making pour-over coffee, such as cup warming, bean soaking and preheating, first instance of coffee making, second instance of coffee making, third instance of coffee making, and so on. These, together with parameters, such as timing and water temperature, allow imitated pour-over coffee to be made.

Cup warming involves warming a piece of coffee filter paper (which has not yet been loaded with coffee granules) with hot water and washing out the smell of the filter paper. At this point in time, the second control module 60 controls how much and for how long hot water is to dispense, whereas the first control module 50 controls the first driving module 310, second driving module 320 or third driving module 420, thereby controlling the area which the hot water is to fall on.

Bean soaking and preheating involves loading the coffee filter paper with coffee granules 63 and then soaking the coffee granules 63 in the hot water such that the coffee granules 63 each absorb water and are pre-heated. At this point in time, the first control module 50 also controls how much and for how long hot water is to dispense, whereas the first driving module 310, second driving module 320 or third driving module 420 allows all the coffee granules 63 to be saturated with the hot water, without allowing the hot water to drip.

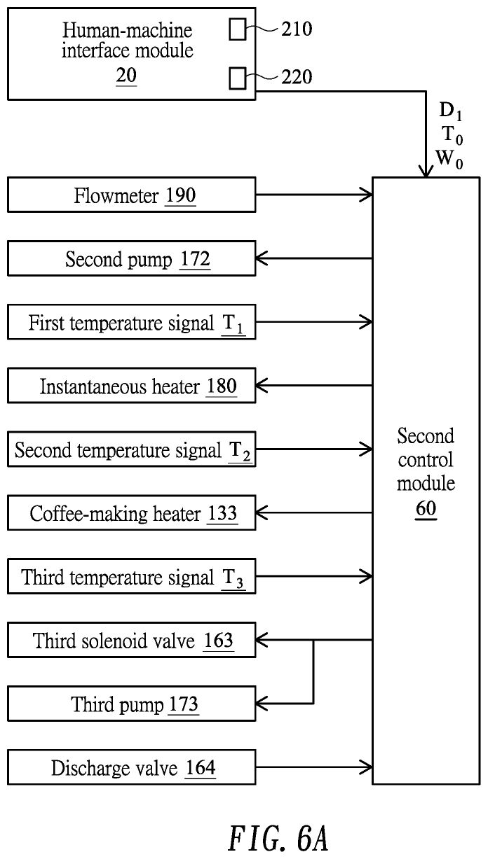

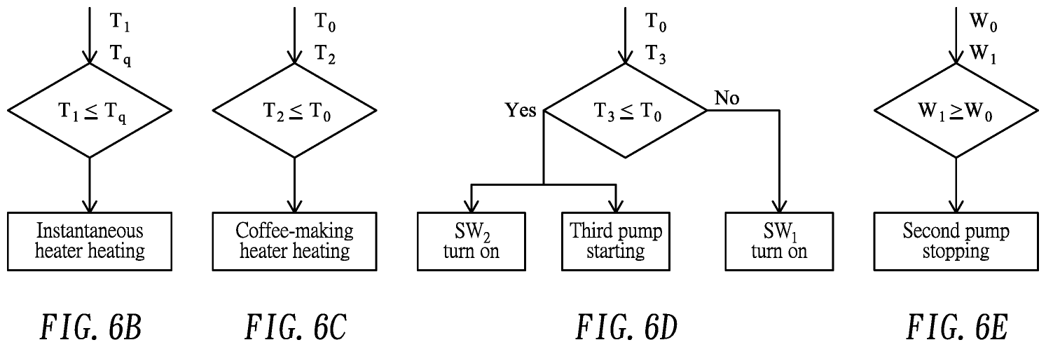

Referring to FIG. 4 and FIG. 6A, water temperature, water quantity, first instance of coffee making, second instance of coffee making, and third instance of coffee making are set beforehand with the program according to the attributes of each coffee flavor. Afterward, the first control module 50 and second control module 60 control the operation of related components.

The description of the aforesaid parameters merely serves exemplary purposes. Priority of each of the parameters can be planned by the users' operating the human-machine interface module 20. In this embodiment, coffee granules 73 are contained in a coffee filter paper container 71, whereas the first driving module 310, second driving module 320 and third driving module 420 not only control the delivery head 330 to move in a first direction 710 and a second direction 720 but also control the delivery head 330 to interact with the coffee cup 70 rotating in a rotational direction 730. Thus, the delivery head 330 can perform imitated pour-over coffee-making operation 72 which involves rotations, ascents and descents, allowing the imitated pour-over coffee maker 100 to make imitated pour-over coffee with the same effect or flavor as manually made coffee. Referring to FIG. 6A, the users enter a command to the human-machine interface module 20, such that the human-machine interface module 20 generates a control signal and sends the control signal to the second control module 60. The second control module 60 reads signals generated by the human-machine interface module 20, which requires the steps below.

Read a coffee-making command Di of the human-machine interface module 20 and drive the second pump 172 to supply hot water for use in coffee making.

Referring to FIG. 6B, read the first temperature signal T₁ of the first temperature sensor S₁ to control the heating operation of the instantaneous heater 180. The instantaneous heater 180 quickly supplies the first-stage coffee-making hot water. In general, the predetermined dispensed water temperature Tq of the instantaneous heater 180 is placed under control; thus, the second control module 60 controls the heating operation of the instantaneous heater 180 to keep the dispensed water temperature at 80-90° C.

Referring to FIG. 6C, read the set temperature T₀ of the human-machine interface module 20 and the second temperature signal T₂ of the second temperature sensor S₂ in order to control the heating operation of the coffee-making heater 133. The coffee-making heater 133 is conventionally a high-power heater. The coffee-making heater 133 heats up the coffee-making tank 131 to attain the water temperature most suitable for coffee making.

The water temperature most suitable for coffee making depends on the set temperature T₀ of the human-machine interface module 20. After a user has chosen a type of coffee or a coffee-making mode with the human-machine interface module 20, the human-machine interface module 20 sends the set temperature T₀ corresponding to the chosen type of coffee or coffee-making mode to the second control module 60. Thus, the second control module 60 deems the set temperature T₀ the best temperature for coffee making and controls the coffee-making heater 133 to heat up the coffee-making tank 131 to attain the best coffee-making temperature.

Referring to FIG. 6D, read the set temperature T₀ of the human-machine interface module 20 and a third temperature signal T₃ of the third temperature sensor S₃ to control the third solenoid valve 163 to perform a coffee-making commencement operation SW₁ or perform a water-return commencement operation SW₂ for returning water to the coffee-making tank 131. The quality of coffee making is affected, because at the beginning of the process of coffee making the water in the pipeline between the coffee-making tank 131 and the delivery head 330 has a much lower temperature.

To maintain the desired coffee-making water temperature of the delivery head 330, the water returns to the coffee-making tank in order to be heated up again, and the coffee making operation cannot be performed by the delivery head 330, when the third temperature sensor S₃ detects that the dispensed water temperature of the delivery head 330, i.e., the third temperature signal T₃, is not equal to the best coffee-making temperature of the set temperature T₀, even though the third solenoid valve 163 performs water-return commencement operation SW₂.

To render the water-return smooth, a third pump 173 is disposed between the third solenoid valve 163 and the coffee-making tank 131 and adapted to perform water-return commencement operation together with the third solenoid valve 163 synchronously. The delivery head 330 performs coffee-making operation, when the third temperature sensor S₃ detects that the dispensed water temperature of the delivery head 330, i.e., the third temperature signal T₃, is equal to the best coffee-making temperature of the set temperature T₀, even though the third solenoid valve 163 performs coffee-making commencement operation SW₁.

Referring to FIG. 6E, considering that the amount of water required to making coffee depends on the type of coffee to make, a flowmeter 190 is disposed between the coffee-making tank 131 and the water tank 121. The second control module 60 reads and uses the set water level W₀ of the human-machine interface module 20 as a predetermined value, reads the actual flow rate W₁ of the flowmeter 190, and compares the predetermined value with the actual flow rate W₁, so as to stop driving the second pump 172 when the actual flow rate W₁ reaches the set water level W₀, thereby controlling the amount of water required for coffee making.

The coffee-making tank 131 has to be rinsed after long use. To this end, the coffee-making tank 131 further has a discharge valve 164. When the users select a rinsing button of the human-machine interface module 20, the second control module 60 controls the discharge valve 164 to open in order to discharge waste water resulting from a rinsing process.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. An imitated pour-over coffee maker capable of high-temperature control, comprising:
a body comprising a main casing and a base, the body having therein:
a water tank in communication with a water source through a first solenoid valve;
a first water gauge located at a position for measuring a level of water in the water tank and adapted to control the first solenoid valve to open or shut;
a coffee-making tank being in communication with the water tank through a first pump, a second solenoid valve and an instantaneous heater and having a coffee-making heater;
a second water gauge located at a position for measuring a level of water in the coffee-making tank and adapted to control the first pump and the second solenoid valve to open or shut;
a first temperature sensor disposed at an outlet end of the instantaneous heater;
a second temperature sensor located at a position for measuring a temperature of water in the coffee-making tank; and
a flowmeter disposed between the coffee-making tank and the water tank;
a human-machine interface module disposed at a top of the main casing;
a first coffee-making module comprising:
a first driving module for enabling its first moving unit to perform a first motion operation;
a second driving module fixedly disposed on the first moving unit and adapted to drive its second moving unit to perform a second motion operation; and
a delivery head fixedly disposed on the second moving unit and having a water inlet in communication with a water outlet of the coffee-making tank through a second pump and a third solenoid valve; and
a third temperature sensor disposed at a position for sensing a temperature of water dispensed by the delivery head;
a second coffee-making module comprising:
a cup holder disposed at the base; and
a third driving module for controlling the cup holder to perform rotation operation;
a first control module for reading a signal of the human-machine interface module and then controlling the first driving module and the second driving module to not only allow the delivery head to perform upward, downward, forward and backward coffee-making operation but also control the third driving module to drive rotation of a coffee cup ready to contain coffee to be made, thereby performing imitated pour-over coffee making operation; and
a second control module for reading a signal of the human-machine interface module and performing the steps of:
reading a coffee-making command of the human-machine interface module, driving the second pump to supply coffee-making hot water, reading a set water level of the human-machine interface module to use the set water level as a predetermined value, reading an actual flow rate shown on the flowmeter, comparing the predetermined value with the actual flow rate, so as to stop driving the second pump when the actual flow rate reaches the set water level;
reading a first temperature signal of the first temperature sensor and a predetermined dispensed water temperature of the instantaneous heater, thereby controlling a heating operation of the instantaneous heater;
reading the set temperature of the human-machine interface module and a second temperature signal of the second temperature sensor, thereby controlling a heating operation of the coffee-making heater; and
reading the set temperature of the human-machine interface module and a third temperature signal of the third temperature sensor, so as to control the third solenoid valve to perform a coffee-making commencement operation or perform a water-return commencement operation for returning water to the coffee-making tank.

2. The imitated pour-over coffee maker of claim 1, wherein the human-machine interface module is a touchscreen or a button assembly.

3. The imitated pour-over coffee maker of claim 1, wherein the first motion operation is a horizontal motion operation.

4. The imitated pour-over coffee maker of claim 1, wherein the second motion operation is a vertical motion operation.

5. The imitated pour-over coffee maker of claim 1, wherein the first driving module is a linear rail or a ball screw positioning transmission mechanism.

6. The imitated pour-over coffee maker of claim 1, wherein the second driving module is a linear rail or a ball screw positioning transmission mechanism.

7. The imitated pour-over coffee maker of claim 1, wherein the third driving module is a motor.

8. The imitated pour-over coffee maker of claim 1, wherein the control module is a programmable controller.

9. The imitated pour-over coffee maker of claim 8, wherein the programmable controller is a microcontroller unit.

10. The imitated pour-over coffee maker of claim 1, wherein capacity of the first water tank is at least three times greater than that of the coffee-making tank.

11. The imitated pour-over coffee maker of claim 1, wherein a third pump is disposed between the second solenoid valve and the coffee-making tank.

12. The imitated pour-over coffee maker of claim 1, wherein the coffee-making tank further has a discharge valve.
